(19) United States
(12) Patent Application Publication
(10) Pub. No.: US 2002/0199032 A1
(43) Pub. Date: Dec. 26, 2002

(54) Deferred response component manager

(75) Inventors: Glenn R. Seidman, Woodside, CA (US); William T. Duffy, San Jose, CA (US)

Correspondence Address: MICHAEL B. EINSCHLAG, 25680 FERNHILL DRIVE, LOS ALTOS HILLS, CA, 94024, US

(73) Assignee: Verano

(21) Appl. No.: 09/879,707

(22) Filed: Jun. 12, 2001

(51) Int. Cl. G06F 9/00

(52) U.S. Cl. 709/315

(57) ABSTRACT

One embodiment of the present invention is a component manager that manages one or more deferred response components wherein each deferred response component has at least one method designated as having a deferred response, the component manager including an interface constructor that automatically constructs: (a) a Requester interface implementation for each deferred response component; and (b) a Responder interface implementation for each deferred response component.

### TECHNICAL FIELD OF THE INVENTION

The present invention pertains to component managers, components associated with the component managers, and methods and apparatus for fabricating the component managers and their associated components. In particular, the present invention pertains to a deferred response component manager (for example, a deferred response component manager embodied as an Enterprise DeferredResponseBean container) and deferred response components (for example, deferred response components embodied as Enterprise DeferredResponseBeans) associated therewith.

### BACKGROUND OF THE INVENTION

A common enterprise problem today relates to a need for autonomous systems to interact with each other. This problem arises whenever a first autonomous system makes a request of a second autonomous system. Typically, a first time interval from the time the request was made to the time the request will begin to be handled, as well as, a second time interval from the time the request was made to an anticipated time when the request handling will be complete involve long and arbitrary time intervals. In fact, in some instances, a response could be due a year later. Because of this, neither the first nor the second autonomous systems must tie up resources during the first time interval between the request and the response. As a result, resources such as, for example, threads or memory must be released during time intervals corresponding to a waiting period for a response to the request. Additionally, one or both of the autonomous systems may crash in a way that CPU or memory resources related to current requests will be lost.

In accordance with the prior art, in order to effectuate system interaction, software is constructed that provides a mechanism for one autonomous system, acting as a client of another system, to invoke another autonomous system (called the backend system). The mechanism typically includes the one autonomous system's passing a unique identifier it generated for an item being exchanged with to the backend system. In accordance with such methods, each of the autonomous systems independently maintains a unique identifier for an item they are exchanging. This presents a problem in that typically there are an arbitrarily large number of items being exchanged between such autonomous systems, and each rendition of an item in one autonomous system must be correlated to a rendition of the item in the second autonomous system.

In order to handle the system interaction, the backend system that handles the request has software constructed: (a) to handle the request and (b) to maintain a table of unique identifier associations between the client system and the backend system processing the request. Later, whenever a deferred response to the request is returned—an arbitrary time later—by the backend system that handled the request, the unique identifier in the backend system is used to access the table to retrieve the unique identifier transmitted with the original request. The backend system then submits its response (i.e. request result), along with the unique identifier it retrieved, to the client system. Then, the client system utilizes the unique identifier in the response to correlate the response to the original request.

In light of the above, there is a need for method and apparatus that can manage the difficult problem of deferred responses between independent systems without a developer's having explicitly to code to gain such advantages.

### SUMMARY OF THE INVENTION

Embodiments of the present invention advantageously satisfy the above-identified need in the art. In particular, one embodiment of the present invention represents a deferred response component manager (embodied, for example, as a container) that provides freely gained characteristics for deferred responses by associating components with the deferred response component manager (for example, by dropping the component into the container)—along with simple text declarations, representing deferred response instructions for each component (for example, set forth in a deployment descriptor). Advantageously, a deferred response component manager fabricated in accordance with this embodiment provides a simple, unified framework for implementing deferred responses such that a developer need only focus on processing requests rather than also focusing on managing unique identifier associations. In particular, in accordance with one embodiment of the present invention, correlation processing is handled by the component manager by describing generation of correlation information in a deployment descriptor.

Advantageously, embodiments of the present invention will be useful for EAI deployments where application subsystems need to exchange data or where a workflow system is integrated with multiple application subsystems. Specifically, one embodiment of the present invention is a component manager that manages one or more deferred response components wherein each deferred response component has at least one method designated as having a deferred response, the component manager comprising an interface constructor that automatically constructs: (a) a Requester interface implementation for each deferred response component; and (b) a Responder interface implementation for each deferred response component.

### BRIEF DESCRIPTION OF THE FIGURE

FIG. 1 shows a block diagram of a client system interacting with a backend system through an Enterprise DeferredResponse Container that is fabricated in accordance with one embodiment of the present invention;

FIG. 2 shows symbols used in the Detailed Description to describe various software entities and their interrelationships;

FIG. 3 shows various of the interrelationships shown in FIG. 1;

FIG. 4 shows a component deployment file;

FIG. 5 shows a block diagram of an XML grammar structure of an EDR JAR that is fabricated in accordance with the present invention;

FIG. 6 shows a block diagram of Requester and Responder interfaces for client systems and backend systems inserted into an EDRB Container fabricated in accordance with an embodiment of the present invention; and

FIG. 7 shows a block diagram of software subsystems (along with their interrelationships) that comprise one embodiment of the present invention.

### DETAILED DESCRIPTION

In accordance with one embodiment of the present invention, a deferred response component manager enables software components developed according to a new design pattern to be deployed, and to enjoy advantages for managing the difficult problem of deferred responses between independent systems without having to explicitly code to gain such advantages. In accordance with one or more embodiments of the present invention, the advantageously obtained advantages automated correlation identifier management, and transformation of single object return values into multiple output parameters.

In accordance with one embodiment of the present invention, an Enterprise DeferredResponseBean Container (“EDRB” Container) operates on a network server with a client system and a backend system residing on the same server. Further embodiments of the present invention cover situations where the client system and/or the backend system resides in a distinct server. When the client systems reside in the same network server as the EDRB Container, the client systems may access the EDRB Container in their same process or a distinct process. As will be described in detail below, an EDRB Container that is fabricated in accordance with some the embodiments of the present invention, enable independent systems, for example, the client system and the backend system, to be “bridged” by correlating unique identifiers maintained for a specific data item exchanged between independent subsystems.

An EDRB Container fabricated in accordance with the present invention provides a component manager in the form of a container architecture wherein components, for example, deferred response components may be deployed into the container to gain beneficial dynamics and services. In accordance with one embodiment of the present invention, contracts (for example: a container/component contract; a client/component contract; and a deployment contract) are specified by way of interfaces (the interfaces include an administrative user interface) and a deployment model.

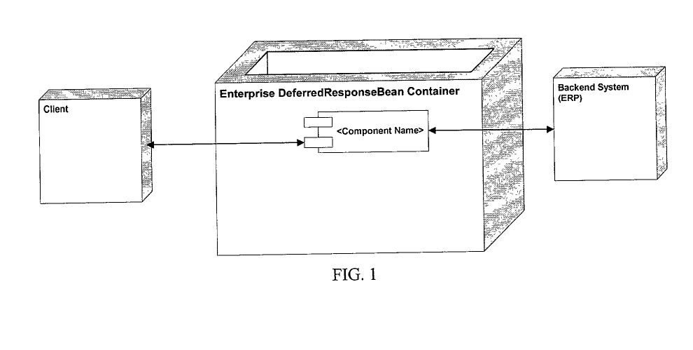

The following detailed description of embodiments of the present invention employs UML structure diagrams that are well known to those of ordinary skill in the art to describe various software entities and their relationships. Note, however, that the container subsystem symbol shown, for example, in FIG. 1, is not an UML standard, but it is used to better illustrate that some embodiments of the present invention comprise a container that “contains” components that get deployed thereinto.

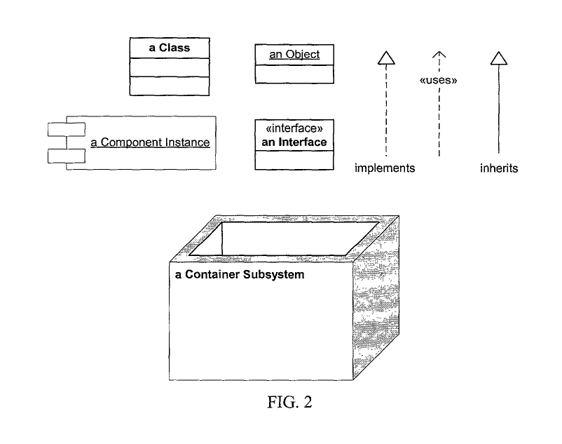

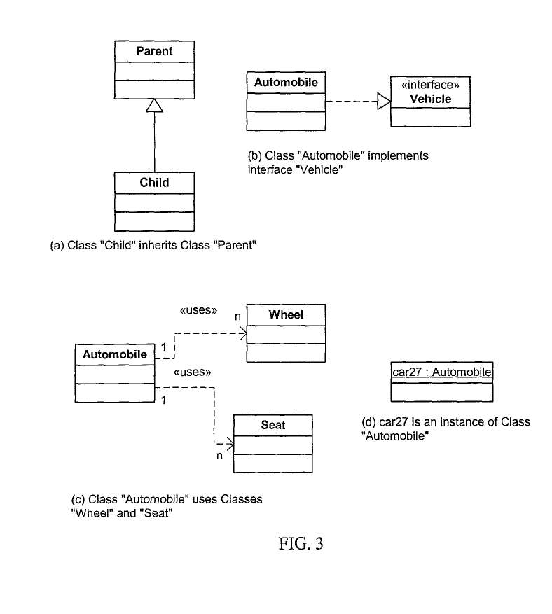

FIG. 2 shows the symbols used herein to describe various software entities and their interrelationships. As shown in FIG. 2, symbol 100 refers to a container subsystem, symbol 110 refers to a class, symbol 120 refers to a component instance, symbol 130 refers to an object, symbol 140 refers to an interface, symbol 150 refers to an interrelationship of “implements,”, symbol 160 refers to an interrelationship of “uses,” and symbol 170 refers to an interrelationship of “inherits.” FIG. 3 shows various of the interrelationships shown in FIG. 2. As shown in FIG. 3a, the class “child” inherits class “Parent.” As further shown in FIG. 3b, class “Automobile” implements interface “Vehicle.” As still further shown in FIG. 3c, class “Automobile” uses classes “Wheel” and “Seat.” Lastly, as further shown in FIG. 3d, car27 is an instance of class “Automobile.”

% FIG. 1 shows a block diagram of a client system interacting with a backend system through an Enterprise DeferredResponse Container (“EDRB” Container) that is fabricated in accordance with one embodiment of the present invention. As shown in FIG. 1, the backend system is labeled “ERP” in parenthesis. ERP refers to Enterprise Resource Planning systems (for example, Financial Systems). The notation ERP is used here because such systems are a stereotypical backend. However, the present invention not limited to use with such systems. In fact, it is contemplated that backend subsystems used with embodiments of the present invention include any kind of subsystem and includes partner across the Internets.

In accordance with one embodiment of the present invention, a DeferredResponse component provides methods that represent services on the backend system. As such, the client system can invoke any one of the methods on the DeferredResponse component that have been designated as having a deferred response by providing its ResponseListener interface whenever it calls the method. Then, in accordance with this embodiment of the present invention, whenever the deferred response eventually arrives, the ResponseListener interface of the client system is invoked to provide the response thereto. Advantageously in accordance with this embodiment of the present invention, development of software is facilitated that: (a) receives incoming requests for a backend system; and (b) processes responses to be sent back to the client system. As was set forth above, using methods of the prior art, such software is cumbersome and complex because of, among other things, unique identifier correlation.

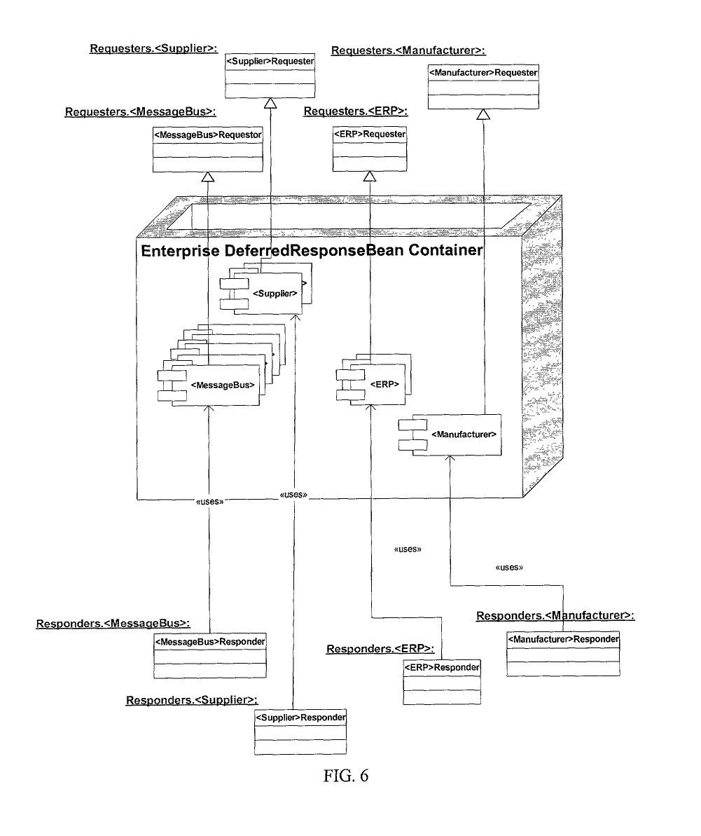

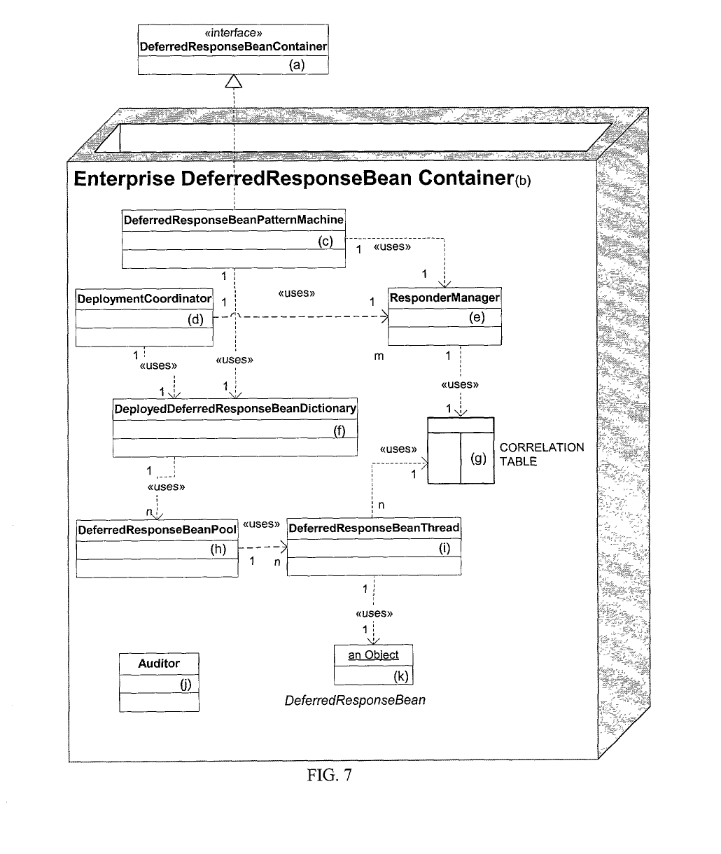

FIG. 7 shows a block diagram of software subsystems (along with their interrelationships) that comprise one embodiment of the present invention. In accordance with this embodiment of the present invention, Enterprise DeferredResponseBean Container 7b manages Enterprise DeferredResponseBeans, and a single interface (DeferredResponseBeanContainer interface 7a) through which requests are made. As shown in FIG. 6, DeferredResponseBeanPatternMachine 7c is the sole implementer of the single DeferredResponseBeanContainer interface 7a. Further, DeferredResponseBeanPatternMachine 7c maintains responsibility to manage the life cycle of Enterprise DeferredResponseBeans. In accordance with one embodiment of the present invention, embodiments of the inventive systems operate by implementing the following: (a) a component manager/component contract; (b) a client/container contract; and (c) a deployment contract.

As shown in FIG. 7, DeploymentCoordinator 7d drives a deployment system while DeferedResponseBeanPatternMachine 7c drives client runtime. Together, DeploymentCoordinator 7d and DeferredResponseBeanPatternMachine 7c initiate processing that may be declared using a deployment descriptor.

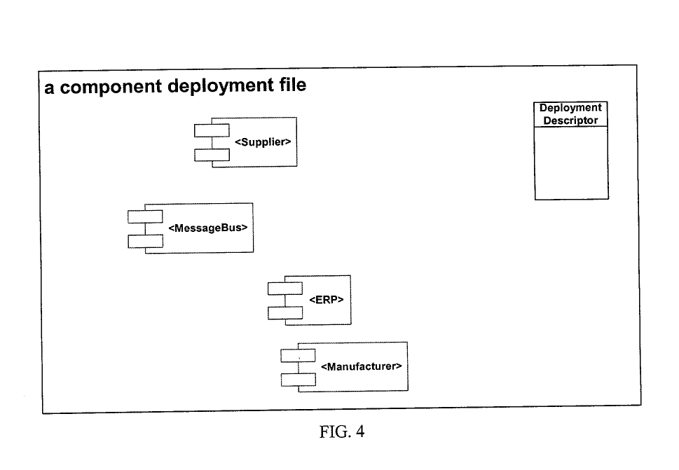

In accordance with this embodiment of the present invention, DeploymentCoordinator 7d receives a deferred response component deployment file utilizing any one of a number of methods that are well known to those of ordinary skill in the art. As will be described in detail below, the deployment file comprises one or more deferred response components along with a deployment descriptor text file (see FIG. 4) that gives declarative instructions to EDRB Container 7b for each component. For example, and without limitation, DeploymentCoordinator 7d can poll a predetermined subdirectory of Enterprise DeferredResponseBean Container 7b for the presence of a new deployment file, or DeploymentCoordinator 7d can be invoked directly by way of an Enterprise JavaBean SessionBean that represents DeploymentCoordinator 7d in accordance with methods that are well known to those of ordinary skill in the art. Then, in response, DeploymentCoordinator 7d reads each of the components in the new deployment file, along with their associated deployment descriptors. In accordance with this embodiment of the present invention, the components read by DeploymentCoordinator 7d may either be a class or a serialized component instance. However, whenever the component read is a class, the class is instantiated in accordance with methods that are well known to those of ordinary skill in the art. Nevertheless, in either case, DeploymentCoordinator 7d deploys a component by making an entry in DeployedDeferredResponseBeanDictionary 7f. The component's deployment descriptor name is used as a key to DeferredResponseBeanPool 7h—but with N copies of the component instance as shown in FIG. 7k where N is the maximum number of threads designated in the deployment descriptor for the component. At the same time, DeploymentCoordinator 7d generates two objects implementing two client interfaces, and stores them in a directory service in accordance with any one of a number of methods that are well known to those of ordinary skill in the art. In accordance with one embodiment of the present invention, one of these client interface objects is stored at a name constructed by concatenation of “Requestor” with a name assigned to the component in the deployment descriptor, and the other one of these client interface objects is stored at a name constructed by concatenation of “Responder” with the name assigned to the component (see FIG. 6). In accordance with this embodiment of the present invention, Requesters are interfaces used by client systems (see FIG. 1) to interact with EDRB Container 7b, and Responders are interfaces that backend systems (FIG. 1) use to interact with EDRB Container 7b.

In accordance with this embodiment of the present invention, the Requester and Responder interfaces generated by EDRB Container 7b (for example, by DeploymentCoordinator 7d) conform to design patterns that make it as easy as possible for client system and backend system developers to integrate their code. In accordance with one embodiment of the present invention, each DeferredResponse component represents an object with methods, and the instance of a class. In accordance with one embodiment of the present invention, an object's entry point signatures can be represented as:

class <deferred response component name> {
returnType₁ method₁(type₁₁ param₁₁, type₁₂ param₁₂, type₁₃ param₁₃)
throws exceptionType₁;
returnType₂ method₂(type₂₁ param₂₁, type₂₂ param₂₂)
throws exceptionType₂;
returnType₃ method₃(type₃₁ param₃₁) throws exceptionType₃;
}
and the Requester client interface generated is:
class < deferred response component name>Requester extends Remote {
void method₁(ResponseListener aResponseListener, String aRequestId,
type₁₁ param₁₁, type₁₂ param₁₂, type₁₃ param₁₃);
void method₂(ResponseListener aResponseListener, String aRequestId,
type₂₁ param₂₁, type₂₂ param₂₂);
void method₃(ResponseListener aResponseListener, String aRequestId,
type₃₁ param₃₁);
}
and the Responder client interface generated is:
class < deferred response component name>Responder {
void method₁(returnType₁ aReturnValue);
void method₁Exception(exceptionType₁ anException);
void method₂(returnType₂ aReturnValue);
void method₂Exception(exceptionType₂ anException);
void method₃(returnType₃ aReturnValue);
void method₃Exception(exceptionType₃ anException);
}

In accordance with this embodiment of the present invention, the Requester client interface has the same method signatures as the associated DeferredResponse component deployed except that the aResponseListener and aRequestId parameters are added. The ResponseListener is a Remote interface provided by the client system when it calls one of the methods. In accordance with this embodiment of the present invention, EDRB Container 7b will automatically and asynchronously invoke the ResponseListener interface whenever a deferred response arrives.

The request id is an identifier that the client system uses to identify its request uniquely. As set forth in the ResponseListener interface listed below, the client system will receive a response later with the same request id. Advantageously, in accordance with this embodiment of the present invention, this enables the client system to match its original request to the response value received.

interface ResponseListener extends Remote{
void returnOutput(String aRequestId, Object aReturnValue);
void returnOutputs(String aRequestId, Vector aListOfOutputs);
}

In accordance with this embodiment of the present invention, DeferredResponseBeanPatternMachine 7c implements processing for all client interface invocations (Requester and Responder). For example, DeferredResponseBeanPatternMachine 7c routes requests to the correct DeferredResponseBeanPool 7h, in accordance with any one of a number of methods that are well known to those of ordinary skill in the art, based on a name of a deferred response component for which a request is intended. In addition, DeferredResponseBeanPatternMachine 7c routes a Responder request to ResponderManager 7e. Thus, as one of ordinary skill in the art can readily appreciate, client-side implementations of both the Requester and Responder classes generated by EDRB Container 7b, invoke DeferredResponseBeanContainer interface 7a as a Remote interface using any one of a number of remote invocation models that are well known to those of ordinary skill in the art, including for example and without limitation, Microsoft DCOM, CORBA, or preferably RMI.

DeferredResponseBeanPatternMachine 7c also manages several administrative functions through its DeferredResponseBeanContainer interface 7a. For example, using DeferredResponseBeanContainer interface 7a, DeferredResponseBeanPatternMachine 7c causes the entire Enterprise DeferredResponseBean Container 7b to be: (a) started; (b) shutdown; (c) queried for currently deployed DeferredResponse components; (d) requested to deploy additional component deployment files into the container; and (e) queried for historic occurrences (i.e., to provide an audit trail of various types) in accordance with methods that are well known to those of ordinary skill in the art.

As mentioned above, in accordance with one embodiment of the present invention, a DeferredResponseBeanPool (for example, DeferredResponseBeanPool 7h) is instantiated, and N associated component instances are constructed for each component deployed. However, to do this, a DeferredResponseThread such as, for example, DeferredResponseBeanThread 7i, that encapsulates each component is constructed in accordance with methods that are well known to those of ordinary skill in the art. As such, each DeferredResponseBeanThread 7i object acts as a “wrapper” for a deferred response component. This wrapper is advantageously used so that a DeferredResponseBeanPool (for example, DeferredResponseBeanPool 7h) can interact with each component in a more complex manner than the component was actually constructed to handle by itself. As one can readily appreciate, advantageously, this provides beneficial behavior that does not need to be coded by a component developer. For example, one embodiment of DeferredResponseBeanThread 7i handles extraction of multiple output values from a single return value on the object method invoked. Further, in accordance with this embodiment of the present invention, and as shown in FIG. 7k, each DeferredResponseBeanThread 7i interacts with a single DeferredResponseBean component as a standard object with methods.

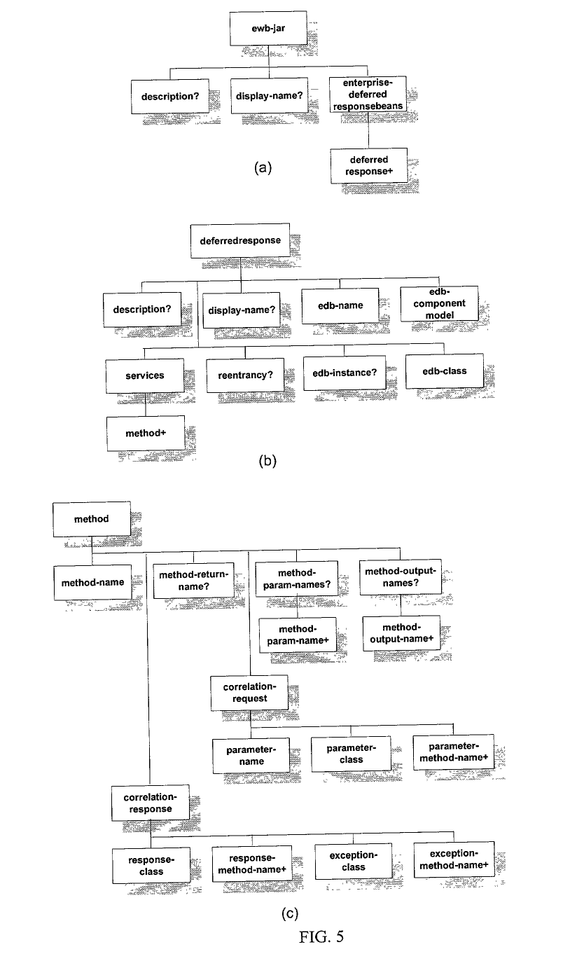

Operational mechanics of an interaction between a client system and a backend system using a DeferredResponse component shown in FIG. 7 largely makes use of correlation-request and correlation-response deployment descriptor elements whose XML DTD model is shown in FIG. 5. In accordance with one embodiment of the present invention, correct and reliable correlation relies on creating persistent Correlation Table 7g which comprises three items per entry: (a) ResponseListener; (b) Request Id; and (c) Request-Correlation Id. Correlation Table 7g can be implemented using any one of a number of methods that are well known to those of ordinary skill in the art. Preferably, Correlation Table 7g will be implemented using a relational database so that entries may be retrieved quickly using an index.

In accordance with one embodiment of the present invention, the first two items in an entry of Correlation Table 7g (i.e., ResponseListener and Request Id) are obtained from the first two parameters of a Requester interface call. Since ResponseListener is a Remote interface, it can be persisted, and the Request Id is a String that is readily stored in Correlation Table 7g. In accordance with this embodiment, the Request-Correlation Id is a unique Identifier that is derived from a request-correlation deployment descriptor element by activities of DeferredResponseBeanThread 7i prior to an actual method invocation on a DeferredResponseBean itself (in a manner that will be explained in detail below). In accordance with this embodiment, the Request-Correlation Id is specified on a per method basis, and, in particular, it specifies a parameter-name, parameter-class, and one or more parameter-methods. The parameter-name identifies one of the parameters of the method being called (representing a request) as the parameter from which a unique correlation identifier will be extracted. The parameter is then cast to the parameter-class designated. This is done because the type of the parameter in an actual method signature may be very general, and it may not provide a method from which to generate a unique correlation identifier. Once the parameter is cast to an object of the specified class, the parameter-methods may be invoked in sequence. Each such parameter-method invocation will return an object that is then converted to a String. Preferably, Java's toString( ) method can be used for this operation. The results of each such parameter-method invocation are then concatenated in the order in which they are listed in the deployment descriptor. The resulting concatenated String is used as a unique identifier that represents the Request-Correlation id. Then, DeferredResponseBeanThead 7i: (a) stores the Request-Correlation Id in Correlation Table 7g; and (b) calls the actual method on the DeferredResponseBean (for example, DeferredResponseBean 7k). Advantageously, in accordance with this embodiment of the present invention, code in a DeferredResponseBean is totally unaware of the correlation activities.

For example, assume that a method on an SAP DeferredResponse component is called processPO, and that it has the three parameters listed. Further assume that the “aFinancialDoc” parameter contains unique correlation id information, but that interface Document provides no method of returning a unique value. Additionally, assume that the actual class expected is SAPPurchaseOrder as in the class listed below. In this case, parameter-name would be “aFinancialDoc”, parameter-class would be “SAPPurchaseOrder”, and parameter-method would be “getPONumber”.

class SAP { //example of simple DeferredResponseBean with one
method.
PurchaseOrderAck processPO(Account anAccount, Supervisor
aSupervisor,
Document aFinancialDoc);
}
class SAPPurchaseOrder implements Document {
Integer getPONumber(void);
stringClass getSupplierName(void);
}

At this point, the DeferredResponseBean method executes, and it is expected to communicate some information having to do with the method invoked, along with the method parameters, to the backend system. The DeferredResponseBean (for example, DeferredResponseBean 7k) completes after this interaction, and frees its associated DeferredResponseBeanThread (for example, DeferredResponseBeanThread 7i).

Meanwhile, the backend system begins processing its newly received data with totally external processes. These backend system processes are expected to respond after an arbitrarily long time interval. Whenever these backend system processes are ready to respond with a result, however, the external process obtains the appropriate Responder interface from the directory service in accordance with any one of a number of methods that are well known to those of ordinary skill in the art, and calls the corresponding method. The Responder client object method invocation ultimately invokes ResponderManager 7e with the name of the method and the single parameter representing the return result. ResponderManager 7e employs the correlation-response element in the deployment descriptor for the method called. In accordance with this embodiment, the Responder method called corresponds to the original request method called. In accordance with this embodiment of the present invention, the correlation-response element in the deployment descriptor comprises a response-class and one or more response-method elements, which are used in a manner that is similar to the manner in which the correlation-request was used. The value in the single parameter of the Responder method called represents the single return value and is cast to the class designated in response-class. The parameter-methods designated in the one or more response-method-name elements are then invoked in sequence, and concatenated to produce a unique identifier (Response-Correlation Id) by converting each returned object to a String. This Response-Correlation Id is then looked up in Correlation Table 7g to find the matching Request-Correlation Id that was stored previously on the way in. When a match is found, both the ResponseListener and the client's request id are used in a call back to the client system via ResponseListener.returnOutput(aRequestId, aReturnValue). It is then the client system's burden to use the Request Id supplied to pair up the return value to some object expecting the response value.

In accordance with one embodiment of the present invention, if there is a problem on the backend system for a particular request, the backend system may submit an exception by calling an appropriate method with an “Exception” suffix, and passing the Exception object as input. In this case, DeferredResponseBeanThread 7i will utilize the exception-class and exception-methods to produce the response correlation identifier.

Whenever the method finally responds and returns an object as the return value, the deployment descriptor may have designated multiple output values for this method. If this is the case, the method element in the deployment descriptor will comprise one or more names of outputs. DeferredResponseBeanThread 7i extracts these outputs from the single return value of the method by calling “property read” methods on the single object. In accordance with this embodiment, the names of the property read methods are formed by concatenating a string “get”+<output name> for each output name listed. A method with these names is then invoked on the single return object for each output name listed. Then, the values obtained are assembled into a vector. These multiple outputs may then be returned to the client system utilizing the returnOutputs( ) method that returns a Vector.

One example of a client system and backend subsystem interaction via a DeferredResponse component is a workflow system acting as a client system to an SAP backend (or other financial system). Workflow systems have activity implementations that can be a DeferredResponse component representing SAP. Whenever workitems are employed as a source of information for requesting a service on the SAP system, the workitem's Activity ID can be utilized advantageously as a request id. Whenever a response comes back with the original request id, this is actually a workitem's Activity ID. The workflow system may then find the workitem and update it with the response return value.

Finally, DeferredResponseBeanPatternMachine 7c DeploymentCoordinator 7d, DeferredResponseBeanPools (for example, DeferredResponseBeanPool 7h), and DeferredResponseBeanThreads (for example, DeferredResponseBeanThread 7i) may all use Auditor class 7j in accordance with methods that are well known to those of ordinary skill in the art to record any salient occurrences in order to maintain an historic audit trail which may be queried any time later in accordance with methods that are well known to those of ordinary skill in the art.

The following describes the deployment of Enterprise DeferredResponseBeans. In accordance with one embodiment of the present invention, one or more deferred response components are packed into a single file, along with a deployment descriptor text file that provides declarative instructions for each component to the container. This file is deployed into the container in the manner described above. For example, as was described above, whenever a deferred response component is deployed, the container automatically generates an object implementing a client interface and stores it in a directory service located at a name assigned to the deferred response component in the deployment descriptor (see FIG. 4).

When deferred response components have been coded, they are ready for deployment. In accordance with one embodiment of the present invention, in order to deploy one or more deferred response components at the same time, their executable file forms are put into a single file such as a ZIP file or other file format that is able to maintain an internal directory structure and store one or more embedded files. Each deferred response component may reside anywhere in the internal directory structure, and components may be grouped into the same or multiple deployment files for organizational purposes. An example of a component deployment file is shown in FIG. 4. Note that a name in angle brackets is actually an exemplar for categories of different entities that may represent a deferred response component. For example, <ERP> might be replaced with “OracleFinancials” and <MessageBus> might be replaced with “TIBCO”. Also shown in FIG. 4 is a text file known as a deployment descriptor that is located, for example, and without limitation, in an internal directory “META-INF”. The deployment descriptor provides deployment configuration instructions to the container for each deferred response component. In accordance with a preferred embodiment of the present invention, XML is used to declare such deployment instructions. Specifically, deployment instructions for each deferred response component comprises: a string designating a directory name for the component (for example, its JNDI name); a string designating an internal deployment file path name to a file containing executable code for the component; a string designating an internal deployment file path name to a serialized state of an instance; a string designating a name of the component model (for example, Java, Microsoft COM, CORBA, or any other component models); an integer designating a maximum number of threads that the EDRB Container will construct for the component, strings designating names of methods to be made available for deferred responses; additional strings per method declaring names of parameters; additional strings per method declaring names of two or more outputs for cases where there is more than one output; additional strings specifying a parameter, a parameter class; one or more methods to call on a request to produce a correlation identifier; and strings specifying a name of a class and one or more methods to call on the return response object in order to produce a matching correlation identifier.

In accordance with one embodiment of the present invention, Enterprise DeferredResponseBeans may be stored in Enterprise DeferredResponseBean JAR files also referred to herein as “EDR JAR” files (the configuration of the Enterprise DeferredResponseBeans described by an EDRB Deployment Descriptor is also included within the EDRB JAR file). Advantageously, this embodiment enables Enterprise DeferredResponseBeans to be saved, and then deployed at any time.

FIG. 5 shows a block diagram of an XML grammar structure of an EDRB JAR that is fabricated in accordance with one embodiment of the present invention, wherein FIGS. 5b and 5c show deployment instructions for a deferred response component and its associated method element (with correlation-request and correlation-response method elements), respectively.

The following describes EDRB JAR Resource files. In accordance with one embodiment of the present invention, there are three categories of resource files: (a) category 1 relates to support files (for example, external native programs or configuration files); (b) category 2 relates to JNI native libraries (for example, dll or .so files); and (c) category 3 relates to .class and .java files.

Category 1 files are stored in a JAR in a directory that corresponds to the bean name. For example, resources for the bean: dr.verano.edrb_bean.satellite.SatelliteReceiverBean should be stored in the JAR at resources/dr/verano/edrb_bean/satellite/SatelliteReceiverBean/. All files and any files in any subdirectories under this location will be extracted to %EDRB_HOME%/respository/resources/dr/verano/edrb_bean/satellite/SatelliteReceiverBean/ where %EDRB_HOME% is the directory that the EDRB Container was installed.

Category 2 files are stored in a similar location. For the bean dr.verano.edrbbean.satellite.SatelliteReceiverBean native libraries should be stored in the JAR at resources/dr/verano/edrb_bean/satellite/SatelliteReceiverBean/native. All files in this location are extracted to %EDRB_HOME%/repository/resources/native/SatelliteReceiverBean/<JAR_DATE>/ where <JAR_DATE> is the date and time the jar was created.

Category 3 files are stored in the JAR normally, and according to the JavaBean specification.

The following describes how files are extracted at deployment time. In accordance with one embodiment of the present invention, resource files will be extracted from a JAR at deployment time or at EDRB Container start time. If a resource file already exists, the file will be overwritten if the JAR was created after the last modified date of the file. Thus, if one modifies the file and then starts the EDRB Container, the file will not be overwritten, However, if one deploys a newer version of the JAR, the file will be overwritten. At undeployment time (i.e., whenever the JAR is deleted) the resource files will be deleted. In addition, if the deployment descriptor does not include a bean's information, the bean's support files will not be extracted from the JAR file.

In accordance with one embodiment of the present invention, an Enterprise DeferredResponseBean locates its support files at runtime by appending the bean name to a path to the location of a resources directory. For example, in one embodiment of the present invention, a system Java property variable “edrb.workarea” is set to the location of the resources directory. For example, %EDRB_HOME%/repository/resources.

Those skilled in the art will recognize that the foregoing description has been presented for the sake of illustration and description only. As such, it is not intended to be exhaustive or to limit the invention to the precise form disclosed. For example, although embodiments of the present invention have been described using component managers which comprise Enterprise DeferredResponseBean Containers and using components which comprise Enterprise DeferredResponseBeans, those of ordinary skill in the art should readily appreciate that the present invention is not limited to such embodiments. In fact, it is within the spirit of the present invention to include any embodiment of component managers and components. For example, in some embodiments, deferred response may be any objects that support the execution of one or more associated methods as, for example, in object oriented programming. Further, the terms client, client system, and client subsystem also include terms such as, without limitation, client software system or client software subsystem.

Those skilled in the art will recognize that the foregoing description has been presented for the sake of illustration and description only. As such, it is not intended to be exhaustive or to limit the invention to the precise form disclosed.

What is claimed is:

1. A component manager that manages one or more deferred response components wherein each deferred response component has at least one method designated as having a deferred response, the component manager comprising:
an interface constructor that automatically constructs:
a Requester interface implementation for each deferred response component; and
a Responder interface implementation for each deferred response component.

2. The component manager of claim 1 wherein:
the Requester interface comprises methods having a same name as deferred response methods designated for each deferred response component wherein each method has the same parameters but additionally comprises a parameter that represents a client invoking a request and a parameter that represents a request id that identifies the request; and
the Responder interface comprises methods having a same name as deferred response methods designated for each deferred response component wherein each method has the same parameters but additionally comprises a parameter that is a same type as a return value on a deferred response method.

3. The component manager of claim 1 wherein the Requester interface has a name comprised of a deferred response component class name and “Requester” and wherein the Responder interface has a name comprised of a deferred response component class name with “Requester”.

4. The component manager of claim 1 wherein the interface constructor further inserts the Requester and Responder interfaces into a directory service, which directory service is accessible by Requester name to a client and by Responder name to a backend system.

5. The component manager of claim 1 which further comprises:
an invoker, in response to an asynchronous call on a Responder interface indicating that a deferred response method has a result to return, that invokes the deferred response component method asynchronously.

6. The component manager of claim 5 which further comprises:
a correlator that correlates a method invocation representing a request with a method invocation representing a response by matching a request correlation identifier with a response correlation identifier.

7. The component manager of claim 6 wherein the correlator:
generates the request correlation identifier by designating an input parameter and a method to call on an input parameter of a request method; and
generates the response correlation identifier by designating a method to call on a result object.

8. The component manager of claim 7 further comprises a persister that persists a representation of the client associated with both an original request identifier and a request correlation identifier.

9. The component manager of claim 8 further comprises:
a callback that calls back a client whenever the Responder interface is invoked by a backend system to return a result, wherein a response correlation id generated is used to find a matching request correlation identifier obtain an associated client representation.

10. The component manager of claim 1 wherein the interface constructor further automatically constructs:
methods on the Responder interface that comprise a same name as the deferred response methods designated concatenated with “Exception” concatenated and having a single parameter input of type Exception, whereby the backend system invokes such methods to communicate a problem, and wherein the callback generates a response correlation identifier by designating a method to call on an Exception object.

11. The component manager of claim 6 wherein the correlator further designates a parameter class with which to cast a parameter prior to calling a parameter method to produce the request correlation identifier.

12. The component manager of claim 6 wherein the correlator further designates a parameter class with which to cast a response result prior to calling a response method to produce the response correlation identifier.

13. The component manager of claim 12 wherein the correlator further designate a class for an Exception with which to cast the Exception prior to calling an exception method to produce the response correlation identifier.

14. The component manager of claim 6 wherein the correlator further designates and invokes more than one parameter method on a request parameter wherein the more than one parameter method are invoked sequentially to produce results that are used to form the request correlation identifier.

15. The component manager of claim 6 wherein the correlator further designates and invokes more than one parameter method on a response parameter wherein the more than one parameter method are invoked sequentially to produce results that are used to form the response correlation identifier.

16. The component manager of claim 9 wherein the correlator further designates and invokes more than one method on an exception parameter wherein the more than one method are invoked sequentially to produce results that are used to form the response correlation identifier.

17. The component manager of claim 1 further comprises a software component to operate on components implemented in one of the following component models: JavaBeans, Microsoft COM, and CORBA.

18. The component manager of claim 6 wherein the correlator further identifies named fields on a returned result object, extracts them the returned result object, and submits them as multiple output parameters for clients that utilize programming languages supporting multiple outputs returned by value.

19. The component manager of claim 1 further comprises:
an invoker that invokes a deferred response component method whose name identifies a deferred response component class; and
a class instantiator that instantiates the identified deferred response component class prior to being invoked.

20. The component manager of claim 1 further comprises:
a deployer that reads and deploys a file including component classes in the component manager.

21. The component manager of claim 20 further comprises:
a deployer that reads and deploys a file including component instances in the component manager.

22. The component manager of claim 20 wherein the deployer further comprises:
a deployment descriptor interpreter that reads a deployment descriptor included in the file wherein a maximum number of threads per deferred response component protocol may be declared to the component manager.
